(19) United States
(12) Patent Application Publication
(10) Pub. No.: US 2006/0090499 A1
(43) Pub. Date: May 4, 2006

(54) Aluminum construction for a fountain machine

(75) Inventors: William D. Denison, Lake Zurich, IL (US); Gary L. Myers, Monee, IL (US); Richard Paeth, St. Charles, IL (US); Catalin Captarencu, Wheeling, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, LLC, Elk Grove, IL (US)

(21) Appl. No.: 11/247,784

(22) Filed: Oct. 11, 2005

Related U.S. Application Data
(60) Provisional application No. 60/617,986, filed on Oct. 12, 2004.

(51) Int. Cl. F25C 1/00; B67D 5/62

(52) U.S. Cl. 62/390; 62/353

(57) ABSTRACT

The present invention provides a cold drink fountain machine extensively made from aluminum materials including, but not limited to, its frame, exterior panels, and ice agitator. Lighting can be provided by a self-contained cold cathode, neon, or LED lighting module.

### CROSS REFERENCE TO RELATED APPLICATION

This application claims priority to U.S. Provisional Patent Application 60/617,986, filed on Oct. 12, 2004, which is incorporated herein by reference in its entirety.

### TECHNICAL FIELD

The present invention relates generally to cold-drink dispensers (also called “fountain machines”) and, more particularly, to an aluminum frame for a fountain machine.

### BACKGROUND OF THE INVENTION

Fountain machines have been in existence for a number of decades. They are typically manufactured of steel, stainless steel, and plastics. Existing designs of fountain machines requires extensive use of these materials.

The several known methods for installing existing fountain machines are all disadvantageous as these machines are often cumbersome and heavy.

Fountain machines usually house several dispensing heads for drinks, a carbonator, an ice hopper, an ice delivery port, an ice agitator, an ice agitator motor, display lighting consisting of fluorescent bulbs and ballasts, electronics to operate the machine, a frame, and exterior panels. There are disadvantages to current implementations of these parts:

Current plastic ice agitators deteriorate over time leading to premature failures, while stainless steel ice agitators are both heavy and complicated. Their high weight means that a great deal of energy must be used to start the agitator moving. In consequence, the motor driving a stainless steel ice agitator is usually of high torque and cost.

The disadvantage of existing stainless steel frames is high weight and very high cost. Stainless steel exterior panels are also very heavy and costly.

Existing electronics packages are fragmented into sub-systems that replicate common components in each sub-system.

### SUMMARY OF THE INVENTION

In view of the foregoing, the present invention provides a fountain machine whose frame and ice agitator are made of aluminum. Devices made according to the present invention control costs for shipping, manufacturing, and installation by reducing the overall weight of the fountain machine.

Embodiments of the present invention reduce energy consumption for the ice delivery system by providing a low weight, high strength, agitator case made of aluminum.

An object of this invention is to provide alternate lighting systems.

Another object of this invention is to consolidate the control electronics into a single, cost-effective package.

### BRIEF DESCRIPTION OF THE DRAWINGS

While the appended claim sets forth features of the present invention, the invention, together with its objects and advantages, may be best understood from the following detailed description taken in conjunction with the accompanying drawings of which:

FIG. 1 is a perspective view of a fountain machine according to the present invention; and

FIG. 2 is a perspective view of an aluminum ice agitator.

### DETAILED DESCRIPTION OF THE INVENTION

The following description is based on illustrative embodiments of the invention and should not be taken as limiting the invention with regard to alternative embodiments that are not explicitly described herein.

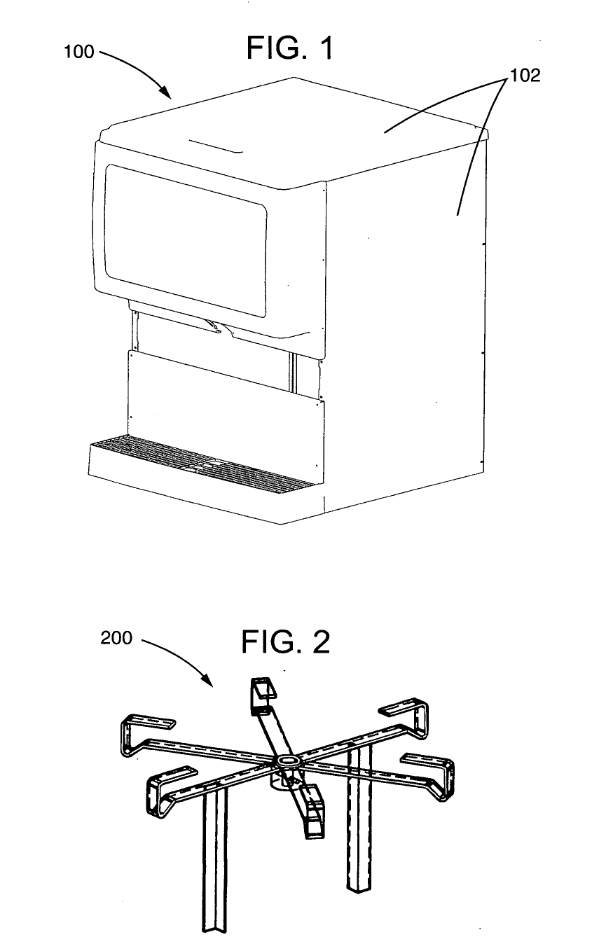

Turning to the drawings, FIG. 1 shows a fountain machine 100 made with aluminum components. The frame of the fountain machine 100 and its attachment hardware are constructed from materials that prevent galvanic reactions within the frame and its fastening system.

The exterior aluminum surfaces 102 of the fountain machine 100 are treated in a manner that mimics the appearance of brushed stainless steel.

FIG. 2 shows an ice agitator 200 made by an aluminum-sand or permanent-mold process.

Lighting according to an embodiment of the present invention is contained in a light box using a cold cathode, an LED, or neon lights. The light box supports the independent bulbs and their associated wiring. In some embodiments, this light box contains a reflector and a front protective clear lens, which eliminates the need to come into contact with the lighting-system bulbs, thus protecting the bulbs. The light box in its entirety can be mounted as a separate item.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

We claim:

1. A fountain machine, the fountain machine comprising:
a support frame made substantially of aluminum;
an ice agitator made substantially of aluminum; and
a motor supported by the support frame and adapted to rotatably drive the ice agitator.
